(19) United States
(12) Patent Application Publication
(10) Pub. No.: US 2009/0284528 A1
(43) Pub. Date: Nov. 19, 2009

(54) Software processing apparatus and method for creating three-dimensional topologically complete surface boundary representations from arbitrary polygon models

(76) Inventors: Tyson Wayne Jensen, San Diego, CA (US); Matthew Brent Strebe, Cardiff By The Sea, CA (US)

Correspondence Address: TYSON JENSEN, 6360 MALLARD ST, SAN DIEGO, CA, 92114, US

(21) Appl. No.: 12/152,611

(22) Filed: May 15, 2008

(51) Int. Cl. G06T 17/00

(52) U.S. Cl. 345/420

(57) ABSTRACT

A software processing apparatus comprising a method for converting arbitrary three-dimensional polygon model data into a mathematically complete topological boundary representation with a determined interior volume such that is sufficiently specified for printing on a three-dimensional printer or similar apparatus without deformation concerning color and surface detail.

### BACKGROUND OF THE INVENTION

1. Field of the Invention

The vast majority of three-dimensional representations of objects in the field of the computing sciences are represented using a technique called polygon modeling. A polygon model is a set of two-dimensional polygons arranged in a three-dimensional space in such a manner as to correspond to the various exterior polygons of a real and physical three-dimensional object. Polygon modeling is used because large surfaces can be represented using a small amount of storage, because retaining information about the interiors of solids is in many cases not necessary, and because certain useful operations such as testing whether two polygons intersect one another are well known from the field of mathematical geometry.

Furthermore, most computer graphical processing units are automatically capable of rendering a list of polygons as a three-dimensional representation on the computer screen without involving the computer's central processing unit or requiring complex programming, which makes the otherwise computationally expensive operation essentially free and further reinforcing the use of polygon models as the primary method for representing three-dimensional data. As a result, the overwhelming majority of existing three-dimensional computer content is stored in the form of polygon models.

Polygon models are not ideal representations for the purpose of creating a three dimensional physical object because they lack definitive information regarding volumes and therefore do not have a defined interior or exterior. Solid physical objects have a well defined interior and exterior-polygon models have no such required definition, and it is not possible to determine whether all printer volume cells are interior or exterior to a polygon model unless the polygon model is complete and every polygon is mathematically adjacent (“welded”) to the polygons next to it, and no extra polygons are present in the interior of the model.

Polygon models can be constructed such that they satisfy the constraints required to trivially indicate interiors and exteriors, and in this case they referred to as boundary representations (“B-Reps” or “BREPS”). However, even true boundary representations can lose the required definition when they are converted from one format to another for various reasons associated with file formats that encourage under specification, rounding errors resulting in points, lines no longer being coincidental, differences amongst various formats regarding the definition of interior, and other common processing errors.

Some computer aided drafting and design software guarantee to export true boundary representations, and printing those three-dimensional models is trivial. However, the vast majority of computer aided drafting and design software do not export true boundary representations, because topological constraints are not important to their primary purpose and guaranteeing a true boundary representation places a number of seemingly arbitrary constraints upon the human operator, such as that all primary operations result in a solid thereby restricting the user from drawing with lines are planes in the manner to which draftsmen have been accustomed historically.

In order to create a physical three-dimensional object from a polygon model, a software processing apparatus must convert polygon model to an intermediate boundary representation, and then must convert that boundary representation into a collection of model volume cells. The printing apparatus can then trivially convert model volume cells into printer volume cells and use that information to create a set of solid particles that will constitute a solid object A model volume cell is trivially convertible to printer volume cell by a fixed correspondence in volume. A printer volume cell corresponds to the volume of media that would be hardened into a solid by a single droplet of ink, by the area of a light used to harden a polymer, or whatever other minimal volume is created by the printer's method for creating a solid. The collection of solidified volume cells constitutes the resulting printed object.

In the service business of three-dimensional printing, it is often the case that a customer's three-dimensional model file is not satisfactorily convertible to a model that can be printed. It is also often the case that a customer's three-dimensional model was developed for a purpose other than to be printed, such as for architectural design or as a video game representation, and the customer wishes to convert the model automatically to an analogous model which is printable.

Furthermore, it would be difficult for a printer manufacturer to realize software capable of serving all possible markets. While algorithms for wrapping arbitrary three-dimensional information with an unambiguous three-dimensional solid exist, the existing methods do not meet the customer's expectations for what the result should look like when printed because artifacts of the process tend to cover over detail, fill in concave areas, and otherwise deform the model.

An intermediate model representation is desired that does not suffer from ambiguities so that it can be printed on any three-dimensional printer, and which looks as much as possible like the source data, and which is capable of serving all markets because it does not use methods based on presumptions which are specific to certain types of objects such as buildings. Concave objects and minor concavities must be supported. Objects might be topologically complex, such as the case of an architectural model with interior walls and furniture. A model might be intentionally hollow, or it might be unintentionally hollow due to missing polygons or gaps, seams, or holes in the polygon model. If the model is not supposed to be hollow, the ambiguity causing the printer to print a hollow object must be resolved. If the model is supposed to be hollow, care must be taken that the model can still be printed such that the exterior walls are thick enough to be self-supporting given the structural integrity constraints of the printer media. If modifications must be made to a model such as the inclusion of holes to allow excess material to be drained from the hollow areas, or the inclusion of supports, sprues, and other re-enforcing structures, these inclusions should not cause additional ambiguities in the model.

2. Description of the Prior Art

Prior art includes a methodology called voxelization, which refers to the conversion of polygon models directly into a collection of adjacent volume cells (hereinafter referred to as voxels) by marking volume cells that intersect the polygon and running the test across the entire volume of the printer's build volume. This is analogous to the conversion of line art to bit-mapped pixels in two-dimensional printing.

Voxelization is rarely used because when voxels are made large enough to resolve ambiguities (i.e., larger than unintentional holes) then they are also large enough to deform the model in an obvious way. When they are small enough not to cause obvious deformity or to be apparent to the observer, then they are too small to fill in unintentional holes and gaps. Voxelization at a high resolution (i.e., with small volume cells) results in a printed collection of plates corresponding to the original polygons, which may or may not be connected, rather than creating a boundary representation with a truly defined and solid interior. Furthermore, once a model has been voxelized, original information that could be used to infer the intent of the original polygon model designer, (such as determining that two planes which are near one another and at right angles should be joined into a corner), is lost because the voxelized model no longer contains any planes or planar directional information. This loss of original intent information makes repair operations after voxelization very difficult Voxelization is not a popular mechanism for polygon model repair for these and similar reasons.

Prior art includes making convex hulls for use in subsequent intersection testing, commonly used in physics simulation. Such convex hulls are not convincing in looking like the original source model, but are interesting in that convex hulls are trivial to print on a three-dimensional printer, and can be generated from any source model.

Prior art also includes topologically derived algorithms based on a “paving” concept such as the “whisker weaving” and “plasterer” algorithms, which are capable of generating a new boundary representation by creating polygons tangential to existing polygons where the borders are extended until they connect such that they create a “wrapping” of the original model. Models that have been processed by a paving algorithm may appear different from the original to varying degrees depending upon the original model topology and completeness. Paving algorithms all suffer from problem such as filling in concavities and paving over surface detail information, and doing so in very obvious and noticeable ways. Furthermore, they cannot be used on models that are supposed to contain holes or hollows, such as a donut or a house with windows and an interior.

### BRIEF SUMMARY OF THE INVENTION

It is a first object of the present invention, which was devised in view of a problem inherent in three-dimensional model printing, to convert any polygon model into a printable solid by automatically and correctly defining the volumes that should constitute interior space without changing the appearance of the model in an obvious or deleterious manner. It is permissible for the algorithm to create new structure where no structure exists in order to better maintain the expected appearance of the final result and to guarantee a complete boundary representation, but it is not permissible to change the appearance of existing model information.

It is a second object of the present invention, which was devised in view of a problem inherent in the case of previously creating a printable solid, to create the solid without requiring on-going interaction with a human operator, such that once started with a set of initial conditions comprising options and preferences that the operation can run automatically and to completion.

The software processing apparatus according to the present invention takes the following construction in order to obviate the first and second problems given above.

On an information processing apparatus, hereinafter called a computer, a software processing apparatus hereinafter called a program or simply “software” reads and processes input models and outputs either models of the same essential format as the input or instructions to a 3d printer to create an analogous solid.

According to the first construction of the software processing apparatus of the present invention, the apparatus comprises a program which first reads a source model. Second, it may optionally read the output of a previous iteration of its processed output performed with different output options to perform incremental improvement. Then, it parses options and preferences as specified. Once this is done it proceeds to analyze the input in accordance with our claims to produce an output model which looks like the input model but which is a completely specified boundary representation, and subsequently writes the model back to storage in the same or similar file format as the original model.

Further, according to a second construction of the software processing apparatus of the present invention, the apparatus comprises a program that translates the output model as per the first construction directly into instructions to control the mechanisms of a three-dimensional printer.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a block diagram illustrating a construction of the software reproducing apparatus in the first embodiment of the present invention. The DETAILED DESCRIPTION OF THE INVENTION describes the block diagram in complete detail.

### DETAILED DESCRIPTION OF THE INVENTION

The description of the present invention will hereinafter be described with reference to drawings.

The invention describes a computationally optimal method for realizing the desired result of the software processing apparatus. It will be obvious to practitioners of the computing sciences that other methods exist for producing the same result, and such embodiments should be contained within the scope of this invention.

The present invention is novel and new in that it employs a “start solid, stay solid” methodology. This methodology when correctly implemented eliminates the possibility of a processing state resulting in a non-solid output that does not comprise a completely specified boundary representation. This embodiment further avoids the mathematical complexity of computing angles and projecting elements. Furthermore, no knowledge of the topology of the model is required in order to accurately represent it because the evolving model has thickness from the very first placed polyhedra and so no defects are introduced when the advancing algorithm wraps back onto itself, as will happen when wrapping a polygon model describing an object with the same topology as a toroid or having hollows.

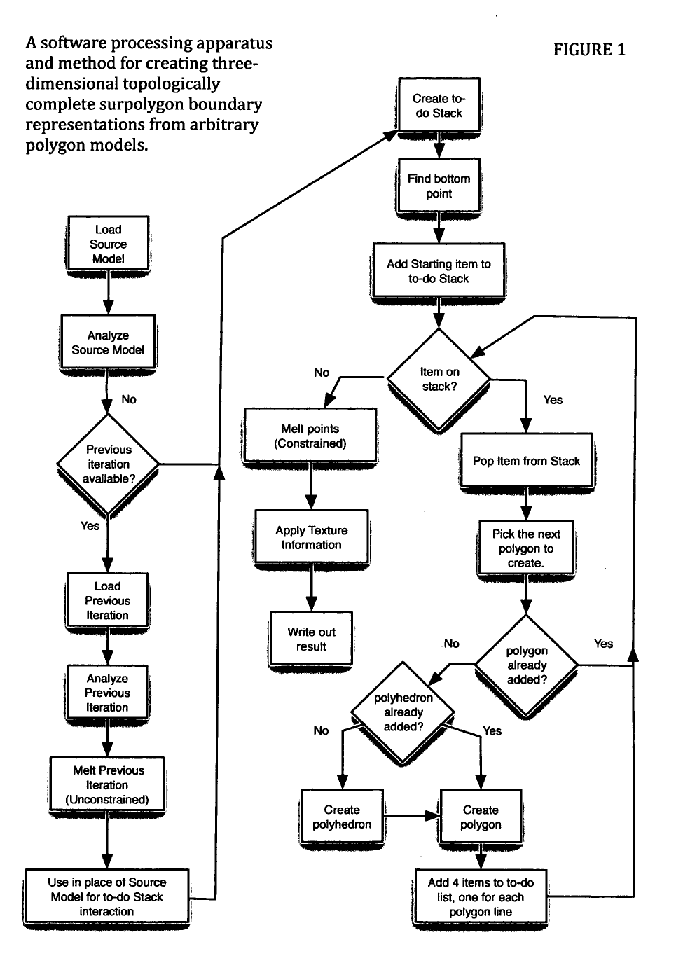

The principle of this embodiment will be discussed referring to FIG. 1.

In this description, the text contained on each step in FIG. 1 are used to label each of the below steps to create an exact and unambiguous correlation between the operation of the embodiment as described in the context of FIG. 1.
1) Perform the following processing step for the element of FIG. 1 annotated as “Load Source Model”: Read the original polygon model from storage into random access memory.
2) Perform the following processing step for the element of FIG. 1 annotated as “Analyze Source Model”: Create an Octree representation of the polygon model representing the source model such that the physical tests for nearest point, polygon, or line and related tests such as intersection testing can be performed efficiently.
3) Perform the following processing step for the element of FIG. 1 annotated as “Previous Iteration available?”: If a previous iteration of output has been specified by the human operator, then perform the following steps:
   a. Perform the following processing step for the element of FIG. 1 annotated as “Load Previous Iteration”: Read the specified intermediate polygon model derived from a previous iteration of the present software apparatus, hereinafter referred to as the intermediate polygon model, from storage into random access memory.
   b. Perform the following processing step for the element of FIG. 1 annotated as “Analyze Source Model”: Create an Octree representation of the intermediate polygon model representing the original source polygon model such that the physical tests for nearest point, polygon, or line and related tests such as intersection testing can be performed efficiently.
   c. Perform the following processing step for the element of FIG. 1 annotated as “Melt Previous Iteration (Unconstrained)”: Move all of the points in the intermediate polygon model to the nearest polygon, line, or point in the original source model, with no constraint on the distance which each point may be moved in order to intersect a polygon present in the original source polygon model, even though such unconstrained movement results in the polygons comprising the intermediate polygon model to contain disconnected and overlapping polygons which no longer comprise a complete and uninterrupted boundary representation. The completeness of the intermediate source polygon model is not important because the result polygon model derived from the present software apparatus again guarantees completeness of the boundary representation. By moving polygons in the intermediate polygon model to the exact plane of the original polygon source model, no increase in deformation is created from one iteration of the software apparatus to the next.
   d. Perform the following processing step for the element of FIG. 1 annotated as “Use in place of source model for to-do stack interaction”: Replace the original polygon source model with the intermediate polygon model comprising the result of the previous step for purposes of interacting with the software processing apparatus in all subsequent steps.
4) Perform the following processing step for the element of FIG. 1 annotated as “Create to-do stack”: Create an empty stack in memory that will contain a list of items to be processed. The stack created is a “last in, first out” stack comprised of a list of items which increases in length at the “top” or “head” end of the list, and from which items are guaranteed to be removed from the “top” or “head” of the list first. Practitioners of the computer programming arts will recognize this as a typical LIFO stack.
   a. An item to be processed consists of a prioritized list of sub-items.
   b. A sub-item consists of a potential exterior polygon and the polyhedron to which it belongs.
5) Perform the following processing step for the element of FIG. 1 annotated as “Find bottom point:” Find a polygon that is known to be exterior and close to the original geometry by searching for the point in the model that is farthest (i.e., has the numerically largest integer axis) in an arbitrarily chosen direction (such as “down”, referred to mathematically as negative Z axis).
   a. Construct a polygon that is tangential to the found point with its normal direction pointing in the aforementioned arbitrary direction (i.e. “down”). A normal direction is a ray perpendicular to the plane of a polygon which is used to determine the directionality of the “sides” of a polygon, i.e., which direction constitutes the “outside” of the polygon and which constitutes the “inside”, and is arbitrarily represented in the field of computer graphics as the progression of points comprising the lines of the polygon in a clockwise (for the “outside” polygon) or counter-clockwise (for the “inside” polygon).
   b. Construct the polyhedron that has the polygon created in step (5)(a) as an item in memory.
c. Associate the polygon and the polyhedron of which it is a constituent polygon for future reference. All polygons are to be bound to polyhedra as part of the “start solid stay solid” concept
6) Perform the following processing step for the element of FIG. 1 annotated as “Add starting item to-do stack”: Place the polygon resulting from processing step (5) into the empty to-do stack as the initial polygon from which all further processing proceeds.
7) Perform the following processing step for the element of FIG. 1 annotated as “Item on stack”: Test to determine whether there exist any items in the to-do stack. When the to-do stack is completely depleted of items awaiting processing, the boundary-finding process has completed and processing flows to processing step (8) annotated in FIG. 1 as “Melt points (constrained)”. If items remain in the to-do stack, perform the following steps:
   a. Perform the following processing step for the element of FIG. 1 annotated as “Pop Item from Stack”: Remove the top item from the stack for subsequent processing as described in the below steps:
      i. Perform the following processing step for the element of FIG. 1 annotated as “Face already added?”: A todo item consists of three possible polyhedron-polygon combinations, the lowest priority item is guaranteed valid. Check each in turn to see if it is valid by intersecting the potential polyhedron with the intermediate polygon model. If an intersection occurs, the face is valid, proceed with this polyhedron-polygon combination to step 7.a.ii.
      ii. Perform the following processing step for the element of FIG. 1 annotated as “Create Face/Cube”: Determine if the result of step 7.a.i, being comprised of a polygon and polyhedron combined object, has already been added to the resulting polygon model (output model) in a previous iteration of step (7) in this process. If so, skip this item and return processing to step (7) “Item on Stack”.
      iii. Perform the following processing step for the element of FIG. 1 annotated as “Cube already added?”: Determine if a different combination consisting of the same polyhedron but a different face was previously added to the result model. This test being quickly performed by tracking polyhedra as separately “indexed” items in the data structure. If so, use the previously created polyhedron and proceed to step 7.a.v.
      iv. Perform the following processing step for the element of FIG. 1 annotated as “Create Cube”: Add to the result model the polyhedron that corresponds to the intersection test performed in 7.a.i.
      v. Perform the following processing step for the element of FIG. 1 annotated as “Create Face”: Add to the result model the polygon that corresponds to the polygon polyhedra combination retrieved from the stack and selected by 7.a.ii.
      vi. Perform the following processing step for the element of FIG. 1 annotated as “Add 4 items to the to-do list, one for each polygon line”: Since this embodiment of the present invention consists of polyhedra comprising cubes, there are 4 lines to test. For each polygon, the normal direction of the polygon and the position of the line uniquely determine the highest, intermediate and lowest priority polygon polygon sub-items. The priority of a polygon polygon sub-item determines which is analyzed first, second and third in future processing steps, and by prioritizing them in the order in which they are most likely to be valid, the software processing apparatus can cause future iterations to automatically invalidate large numbers of polygon polygons which will have already been processed or which are not possibly valid because predicate dependent polygons have already been determined to be invalid, thus speeding the computation of the entire process. One of the three sub-items will always be valid because the lowest priority item is the same polyhedra as have already determined to be valid but with the corresponding polygon that shares the line. After performing this step, return processing to step (7) annotated in FIG. 1 as “Item on Stack.”
8) Perform the following processing step for the element of FIG. 1 annotated as “Melt points (constrained)”: The melting processing operation consists of moving points in the resulting polygon model to the nearest polygon, line, or point in the original source model, constrained such that a point may not be moved farther than the original volumetric boundary of the polyhedra within which it is composed, even if the point does not intersect a polygon in the intermediate polygon model. Constraining movement thus results in models with a minimum permissible thickness and a complete and uninterrupted boundary representation.
9) Perform the following processing step for the element of FIG. 1 annotated as “Apply texture information”: Texture information, being bit-mapped graphical images applied to polygons in order to represent the appearance of a physical object, is applied to the resulting model by transferring the texture information from polygons in the original source model found to be nearest to polygons in the resulting polygon, with such transformations as are appropriate to avoid visual defects such as stretching or seams. Such techniques are well known to practitioners in the field of computer graphical sciences.
10) Perform the following processing step for the element of FIG. 1 annotated as “Write out result”: The resulting collection of polygons is recorded to permanent storage where it may be used as a finished polygon model or as an intermediate polygon model for a subsequent iteration of this process for further refinement at a smaller polyhedra scale.

This invention being thus described, it will be obvious that same may be varied in same way. Such variations are not to be regarded as a departure from the spirit and scope of the invention, and all such modifications as would be obvious to one skilled in the art are intended to be included within the scope of the following claims.

What is claimed is:

1. A software processing apparatus comprising an intermediate representation of a source polygon model, such as an Octree or a binary space partitioning tree (being methods well known to practitioners of the art), employed to build a topologically complete analogous representation from a set of simple non-overlapping polyhedrons, such as cubes, which completely contain the original source polygon model, and in such manner as said polyhedra are placed in cells the size of the polyhedra wherever any polygon from the original source polygon model would intersect a cell, and in such manner that the polyhedra are flush against each other, and there are no more or fewer polyhedra than required to contain the original source polygon model, and such that the set of polyhedra creates a topologically complete analogous representation with no unintentional gaps, spaces, or holes.

2. A software processing apparatus according to claim 1 wherein an additional processing step removes all polygons which are not defined as exterior facing polygons by marking polygons which are coincident with and therefore components of any two polyhedra for removal, such that the remaining polygons create a connected set of exterior polygons and a connected set of interior polygons, and subsequently removing polygons defined by any of a number of trivial methods to constitute interior polygons, including such methods as the set of polygons not connected to the polygon containing the lowest most point in the model, or the set of polygons having the lower total area, and further removing all remaining lines and points unused after this step, resulting in the remaining polygons constituting a topologically complete surface boundary representation comprised of polygons which are coincidental with the polygons of the polyhedral cells and not coincidental with the planes of the polygons of the original source polygon model.

3. A software processing apparatus according to claims 2 wherein existing points used to define the location of polygons are moved from their original locations coincidental with artificial cell boundaries to a location which intersects the planes of the original polygon model in such manner that all lines and polygons that existed before the movement of the point continue to exist and such that no new lines or polygons are created and such that no intersections between existing polygons are created other than those already implied by existing lines, wherein the resulting planes of the polygons corresponds more closely to the planes of the polygons of the original source polygon model data, such that the integrity of the boundary surface representation status of the collection of polygons, lines, and points is preserved. When no original geometry from the original source polygon model exists such as may occur in the area where a hole or unintentional gap has been filled in within the cell boundary of the point, the point is not moved.

4. A software processing apparatus according to claim 1, wherein the initial set of connected polyhedra is constructed by using the intermediate representation to find a starting cell (such as the bottom most polygon in the original model), adding the cell to a stack of cells to check, and while the stack is not empty, retrieving an element from the list and checking whether the cell intersects with any polygon from the source data set. If there is an intersection, a simple polyhedra is constructed to fill the cell. If a simple polyhedra was constructed, the adjacent cells are added to the stack.

5. A software processing apparatus according to claim 4, wherein an improvement is obtained by combining the pruning step and the building connected solids step into a single boundary representation construction step by adding a marker to any polygon known to be on the final boundary representation and using that marker to mark adjacent polygons on neighboring polyhedra, and using marked polygons to make the pruning decisions when markers exist for a polyhedra rather that testing each polygon of a polyhedra to determine whether it is part of the boundary representation. When markers do not exist on a polyhedra, the original tests are used.

6. A software processing apparatus according to claim 2 wherein an improvement derives from processing the original polygon model at a smaller cell size in a subsequent execution of the software apparatus, in such manner as allows the preceding processing step performed at a larger size to cause all unintentional gaps, spaces, or holes in the original model to be covered over by a polyhedra because the polyhedra cell size is larger than the size of the unintended hole, thus ensuring that some polygon of the original model will intersect the cell and cause a polyhedra to be created, and in such manner as the present invention respects both the boundaries defined by the topology created by a previous execution of the software apparatus as well as the topology defined by the original source polygon model, thereby retaining the benefit of large scale topology definition from a previous execution of the present invention at a smaller cell size that may be smaller than unintentional holes in the original model.

7. A software processing apparatus according to claim 6 wherein an additional improvement derives from modifying the model generated by preceding executions of the present invention at larger cell sizes by moving all vertices contained in the model such that they coincide with the polygons of the original source model irrespective of their original locations on the polyhedra cell boundaries, even though this step destroys the guarantee that the model generated by preceding processor steps at larger cell sizes constitutes a topologically complete surface boundary representation, because the subsequent processing step will again guarantee that the result is a topologically complete surface boundary representation so it is not necessary for input models to the processing step be complete.

8. A software processing apparatus according to claim 7 wherein an additional improvement derives from repeating the execution of the present invention multiple times at successively smaller specified cell sizes, resulting in a successively tighter fit to the original model geometry while retaining the topological definition of the surface boundary representation created in the initial processing step.
